(19) United States
(12) Patent Application Publication
(10) Pub. No.: US 2018/0118120 A1
(43) Pub. Date: May 3, 2018

(54) CONSOLE ASSEMBLY WITH SELF-LEVELING STORAGE BIN

(71) Applicant: FORD GLOBAL TECHNOLOGIES, LLC, Dearborn, MI (US)

(72) Inventor: Miguel David Ferreira Orta, Toluca (MX)

(21) Appl. No.: 15/337,653

(22) Filed: Oct. 28, 2016

(51) Int. Cl. B60R 7/04

(52) U.S. Cl. CPC B60R 7/04

(57) ABSTRACT

A console assembly includes a base, a lid attached to the base and a storage bin that is pivotally attached to the lid by a self-leveling feature.

### TECHNICAL FIELD

This document relates generally to the motor vehicle equipment field and, more particularly, to a console assembly, such as a floor console assembly, that incorporates a self-leveling storage bin. Such a storage bin may be particularly adapted for receiving and holding small items such as coins, rings, keys, earrings and the like in an easily accessed position above the floor of the main storage compartment.

### BACKGROUND

It is well known in the art to equip a motor vehicle with a console assembly incorporating a storage compartment accessed by means of a pivotal lid. Many such console assemblies are floor mounted in the space between the seats of the motor vehicle. As a result, many such console assemblies are relatively narrow and the storage compartments contained therein are relatively deep. This makes it very difficult to access small items such as coins, rings, keys, earrings and the like that tend to find their way to the bottom of the storage compartment where they rest upon that compartment floor.

This document relates to a new and improved console assembly incorporating a self-leveling storage bin that is pivotally attached to the lid of the console assembly and functions to hold small items above the floor of the main storage compartment in a position where they may be easily accessed. Advantageously, the self-leveling action of the storage bin helps to prevent shifting and spilling of items contained therein as a result of rapid acceleration or deceleration of the motor vehicle.

### SUMMARY

In accordance with the purposes and benefits described herein, a new and improved console assembly is provided. That console assembly comprises a base, a lid attached to the base and a storage bin pivotally attached to the lid by a first link arm, a second link arm and a pivot feature. The first link arm may be opposed to the second link arm.

The pivot feature may include a first pivot pin connecting the first link arm to the storage bin and a second pivot pin connecting the first link arm to the lid. Further, the pivot feature may also include a third pivot pin connecting the second link arm to the storage bin and a fourth pivot pin connecting the second link arm to the lid. The first pivot pin may be aligned with the third pivot pin while the second pivot pin may be aligned with the fourth pivot pin.

The console assembly may also include a second feature attaching the lid to the base. In addition, a latch mechanism may be provided for locking the lid in a closed position on the base. Still further, the console assembly may include a second storage bin pivotally attached to the lid by a third link arm, a fourth link arm and a third pivot feature. The third link arm may be opposed to the fourth link arm.

The third pivot feature may include a fifth pivot pin connecting the third link arm to the second storage bin and a sixth pivot pin connecting the third link arm to the lid. Further, the third pivot feature may include a seventh pivot pin connecting the fourth link arm to the second storage bin and an eighth pivot pin connecting the fourth link arm to the lid. The fifth pivot pin may be aligned with the seventh pivot pin and the sixth pivot pin may be aligned with the eighth pivot pin.

In accordance with still another aspect, a console assembly comprises a base, a lid attached to the base and a storage bin pivotally attached to the lid by a self-leveling feature. That self-leveling feature may include a first link arm, a second link arm and a pivot feature pivotally attaching the first link arm and the second link arm to the storage bin and the lid. Further, the console assembly may include a second pivot feature attaching the lid to the base.

In the following description, there are shown and described several preferred embodiments of the console assembly. As it should be realized, the console assembly is capable of other, different embodiments and its several details are capable of modification in various, obvious aspects all without departing from the console assembly as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate several aspects of the console assembly and together with the description serve to explain certain principles thereof. In the drawing figures:

FIG. 1 is a perspective view of a first embodiment of the console assembly illustrating the lid in the open position to allow one to access the self-leveling storage bin carried on the lid as well as the main storage compartment in the base of the console assembly.

FIGS. 2a-2c are a series of schematic side elevational views illustrating the position of the self-leveling storage bin when the lid of the console assembly is in closed, partially opened and fully opened positions.

FIG. 3 is a perspective view of a second embodiment of the console assembly illustrating the lid in an opened position.

FIGS. 4a-4e are schematic side elevational views illustrating the second embodiment of the console assembly incorporating two self-leveling storage bins pivotally attached to the lid. FIG. 4a illustrates the console assembly with the lid in a fully closed position. FIG. 4e illustrates the console assembly with the lid in the fully opened position. FIGS. 4b-4d illustrate the lid in progressively further opened positions between the fully closed position illustrated in FIG. 4a and the fully opened position illustrated in FIG. 4e.

Reference will now be made in detail to the present preferred embodiments of the console assembly, examples of which are illustrated in the accompanying drawing figures.

### DETAILED DESCRIPTION

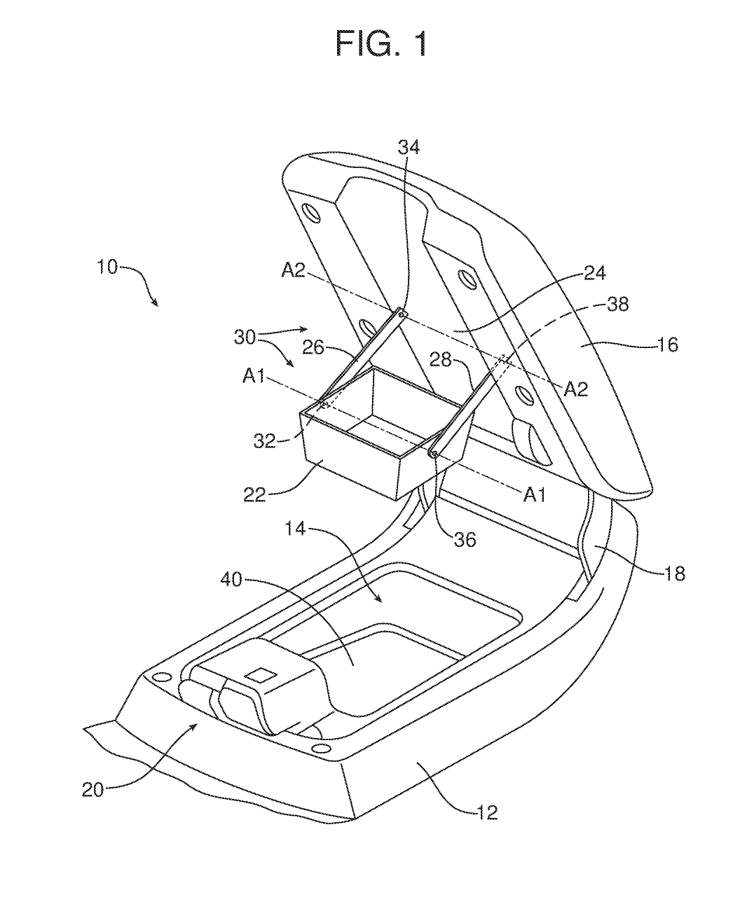

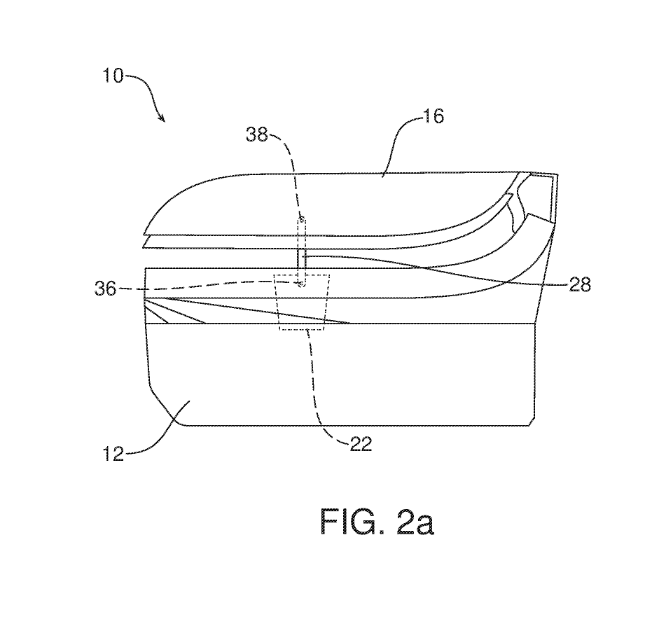

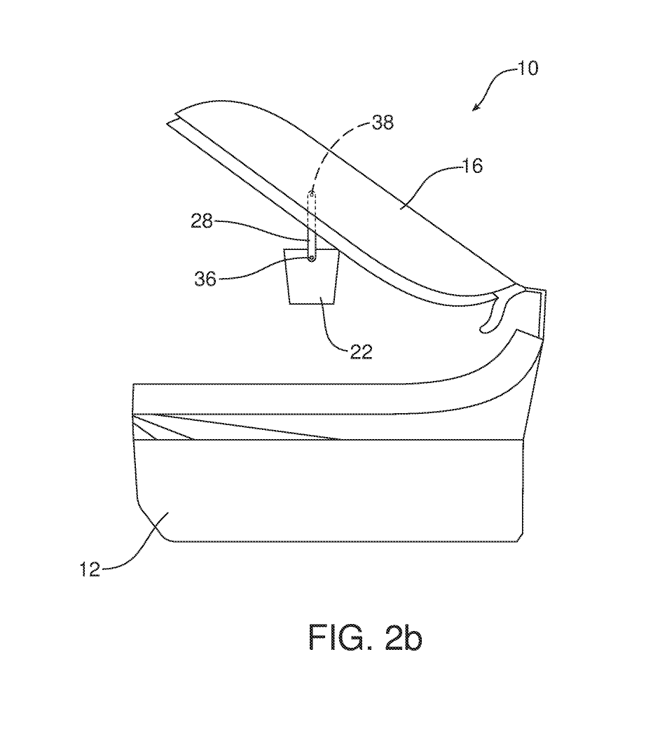

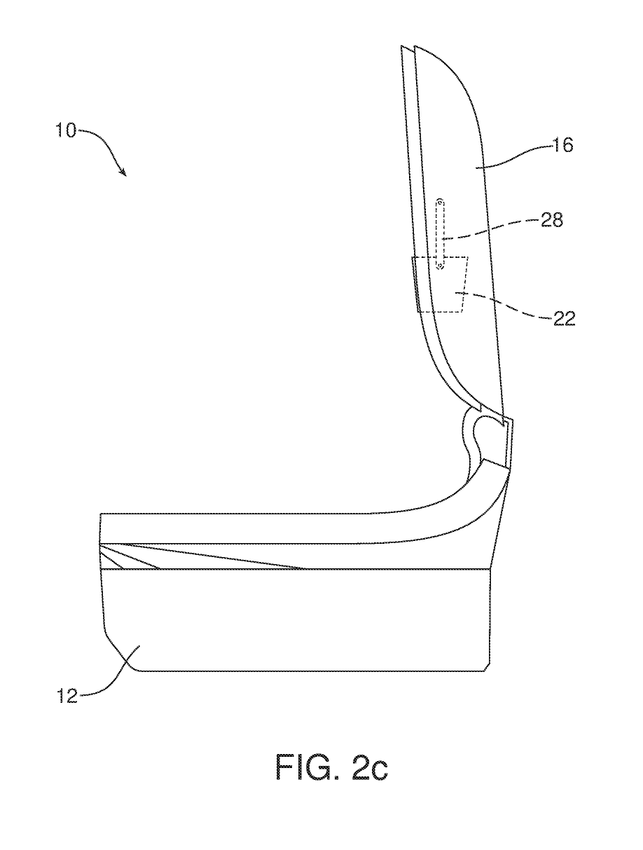

Reference is now made to FIGS. 1, 2a, 2b and 2c illustrating a first embodiment of the new and improved console assembly 10. As best illustrated in FIG. 1, the console assembly 10 includes a base 12 which defines a main storage compartment 14. A lid 16 is pivotally attached to the base 12 by means of a second pivot feature 18 in the form of a hinge of a type known in the art. As illustrated in FIGS. 2a-2c the lid 16 may be displaced between a closed position illustrated in FIG. 2a, a fully opened position illustrated in FIG. 2c and a partially opened/partially closed position illustrated in FIG. 2b. A latch mechanism 20, of a type known in the art, functions to secure the lid in the closed position.

A storage bin 22 is pivotally attached to the inner face 24 of the lid by means of a first link arm 26, second link arm 28 and a pivot feature 30. As illustrated, the first link arm 26 is opposed to the second link arm 28.

The pivot feature 30 includes a first pivot pin 32 connecting a first end of the first link arm 26 to the storage bin 22 and a second pivot pin 34 connecting a second end of the first link arm to the lid 16.

In addition, the pivot feature 30 includes a third pivot pin 36 connecting the third end of the second link arm 28 to the storage bin 22 and a fourth pivot pin 38 connecting the fourth end of the second link arm to the lid 16.

As should be appreciated, the first pivot pin 32 is aligned with the third pivot pin 36 along a first pivot axis A1. Similarly, the second pivot pin 34 and fourth pivot pin 38 are aligned along a second pivot axis A2. As should be appreciated, the first pivot axis A1 substantially bisects the storage bin 22 along the four-aft dimension of the storage bin.

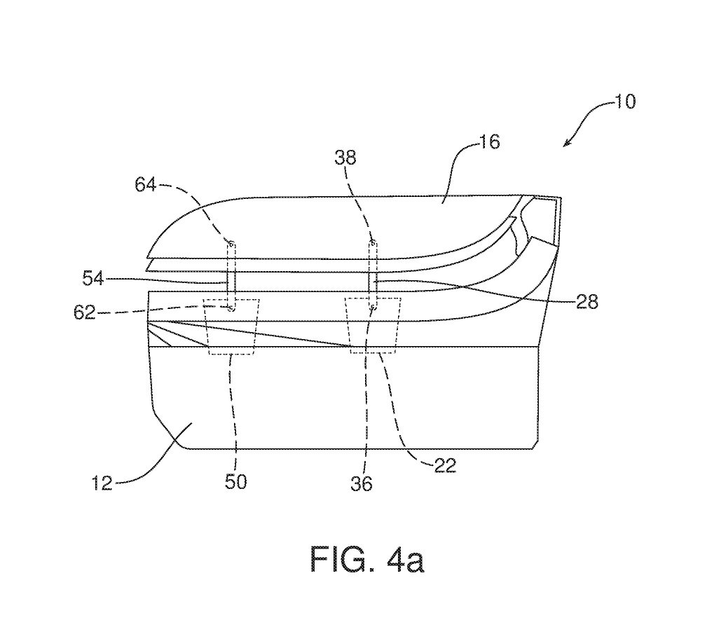

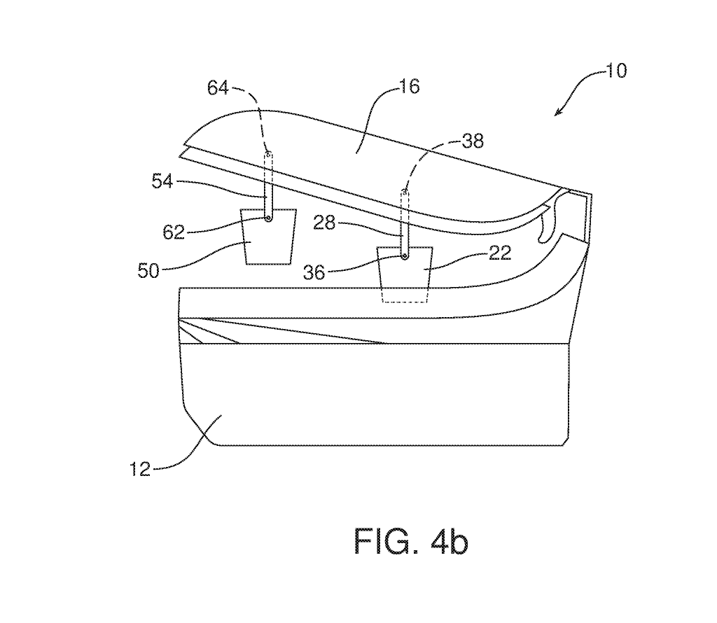

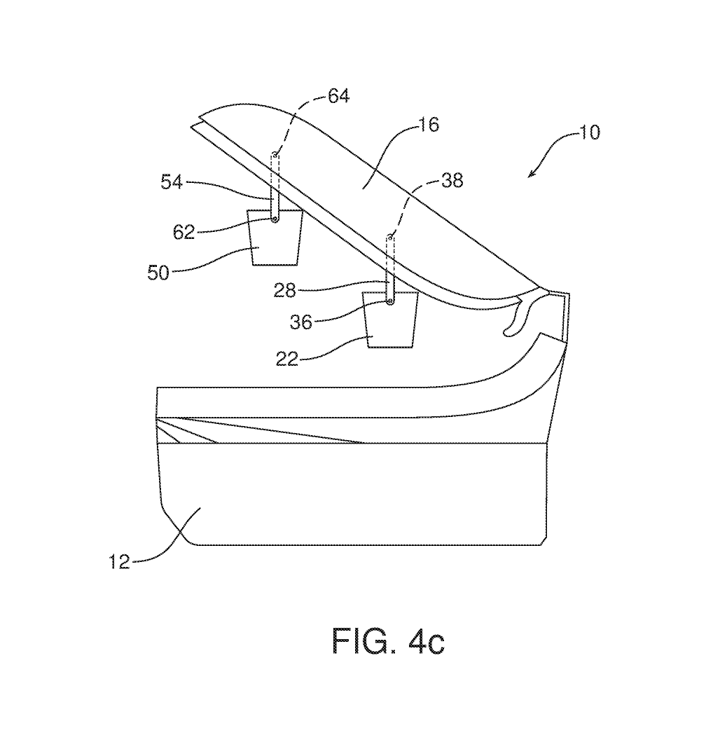

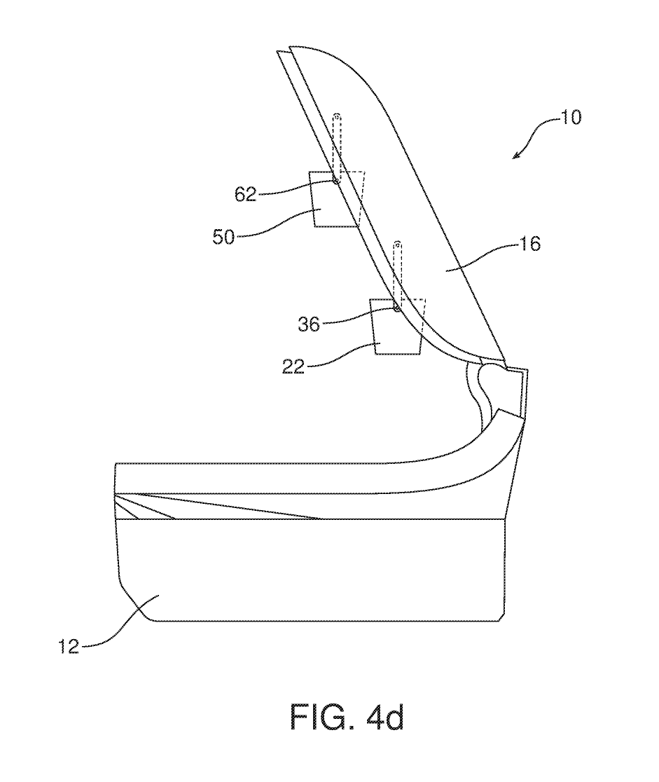

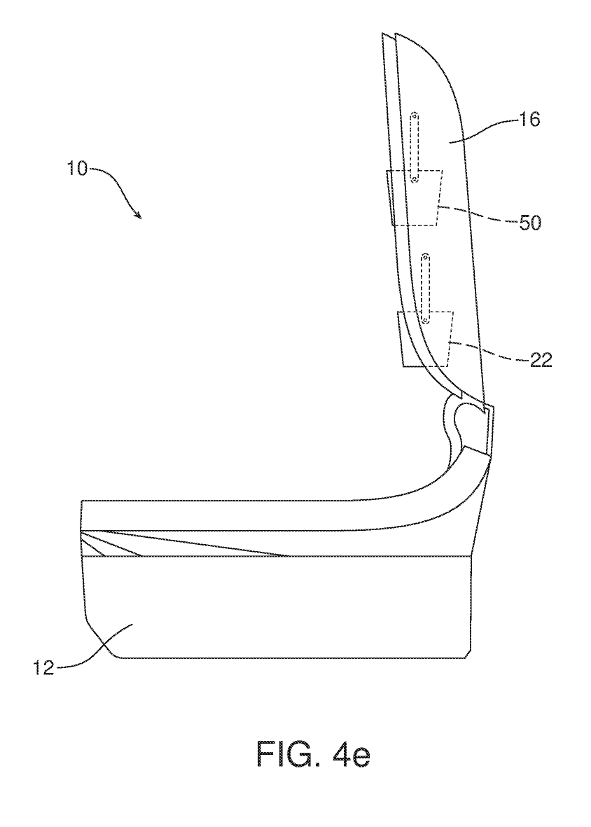

As should be appreciated from viewing FIGS. 2a-2c, the first link arm 26, the second link arm 28 and the pivot feature 30 that pivotally attaches the first and second link arms between the storage bin 22 and the lid 16 all function together as a self-leveling feature to ensure that the contents contained in the storage bin 22 do not fall out of the bin as the lid 16 is displaced between the closed position illustrated in FIG. 2a through the partially opened position illustrated in FIG. 2b to the fully opened position illustrated in FIG. 2c in order to allow access to both the contents in the storage bin 22 and in the main storage compartment 14. As should be appreciated, the raised position of the storage bin 22 well above the floor 40 of the storage compartment 14 ensures easy access to those contents contained in the storage bin 22. Additionally, as illustrated in FIG. 4c, when the lid 16 is in the fully opened position, the storage bin 22 is pivoted rearward into contact with the lid thereby allowing good visibility and access to the storage compartment 14.

When the lid 16 is closed again, the self-leveling storage bin 22 functions as illustrated in FIGS. 2a-2c to maintain the storage bin 22 in a level position and prevent the spilling of any contents from the storage bin.

Since the first pivot axis A1 and the second pivot axis A2 are both parallel to each other and perpendicular to the longitudinal, fore-aft axis of the motor vehicle (X axis), the self-leveling action provided to the storage bin 22 by the first link arm 26, second link arm 28 and pivot feature 30 compensate for sudden motor vehicle acceleration and deceleration to maintain the contents in the storage bin 22.

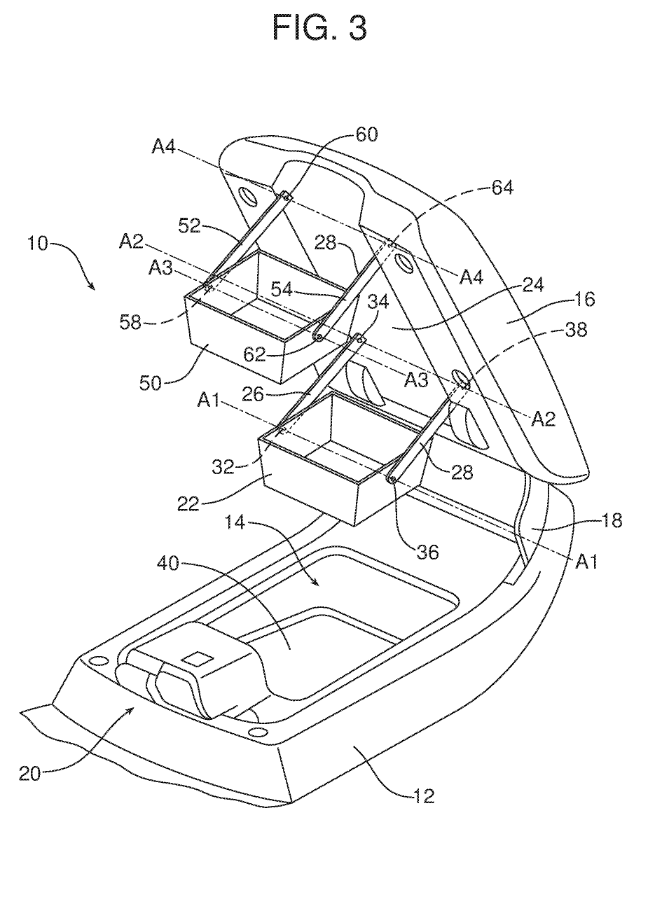

FIGS. 3 and 4a-4e illustrate an alternative embodiment of a console assembly 10 that includes a second storage bin 50. For purposes of brevity of description, those features in common between the first embodiment of the console assembly 10 illustrated in FIGS. 1 and 2a-2c and the second embodiment of the console assembly 10 illustrated in FIGS. 3 and 4a-4e are identified by identical reference numbers.

As illustrated, the second storage bin 50 also includes a self-leveling feature comprising a third link arm 52, a fourth link arm 54 and a third pivot feature 56. Thus, as illustrated, the second storage bin 50 is pivotally attached to the lid 16 by the third link arm 52, the fourth link arm 54 and the third pivot feature 56. That third link arm 52 is opposed to the fourth link arm 54.

The third pivot feature 56 includes a fifth pivot pin 58 connecting the third link arm 52 at one end to the second storage bin 50 and a sixth pivot pin 60 connecting the third link arm at the other end to the lid 16.

In addition, the third pivot feature 56 includes a seventh pivot pin 62 connecting the fourth link arm 54 at one end to the second storage bin 50 and an eighth pivot pin 64 connecting the fourth link arm at the opposite end to the lid 16.

As illustrated, the fifth pivot pin is aligned with the seventh pivot pin along a third pivot axis A3. Similarly, the sixth pivot pin 60 is aligned with the eighth pivot pin 64 along a fourth pivot axis A4.

As illustrated in FIGS. 4a-4e, the storage bins 22, 50 and the link arms 26, 28, 52, 54 are sized and shaped to allow the two storage bins to both self level as the lid is displaced between the fully closed position illustrated in FIG. 4a, through the intermediate positions illustrated in FIGS. 4b-4d to the fully opened position illustrated in FIG. 4e and back again.

In summary, either embodiment of the console assembly 10 provides at least one storage bin 22, 50 with a self-leveling feature that functions to maintain items held therein within the bin as the lid 16 of the console assembly 10 is opened to obtain access to the storage bins and the main storage compartment 14 and the base 12. Advantageously, when the lid 16 is fully opened, the storage bins 22, 50 swing into a position adjacent the lid 16 thereby maximizing the opening for access to the storage compartment 14 while the raised bins simultaneously provide easy access to the small items held in the bins. In addition, as previously noted, the self-leveling storage bins 22, 50 function to compensate for changes in momentum due to the acceleration or deceleration of a motor vehicle thereby effectively maintaining small items in the storage bins 22, 50 in an efficient and effective manner.

The foregoing has been presented for purposes of illustration and description. It is not intended to be exhaustive or to limit the embodiments to the precise form disclosed. Obvious modifications and variations are possible in light of the above teachings. All such modifications and variations are within the scope of the appended claims when interpreted in accordance with the breadth to which they are fairly, legally and equitably entitled.

1. A console assembly, comprising:
a base;
a lid attached to said base; and
a storage bin pivotally attached to said lid by a first link arm, a second link arm and a pivot feature.

2. The console assembly of claim 1, wherein said first link arm is opposed to said second link arm.

3. The console assembly of claim 2, wherein said pivot feature includes a first pivot pin connecting said first link arm to said storage bin and a second pivot pin connecting said first link arm to said lid.

4. The console assembly of claim 3, wherein said pivot feature includes a third pivot pin connecting said second link arm to said storage bin and a fourth pivot pin connecting said second link arm to said lid.

5. The console assembly of claim 4, wherein said first pivot pin is aligned with said third pivot pin and said second pivot pin is aligned with said fourth pivot pin.

6. The console assembly of claim 5, including a second pivot feature attaching said lid to said base.

7. The console assembly of claim 6, further including a latch mechanism for locking said lid in a closed position.

8. The console assembly of claim 6, further including a second storage bin pivotally attached to said lid by a third link arm, a fourth link arm and a third pivot feature.

9. The console assembly of claim 8, wherein said third link arm is opposed to said fourth link arm.

10. The console assembly of claim 9, wherein said third pivot feature includes a fifth pivot pin connecting said third link arm to said second storage bin and a sixth pivot pin connecting said third link arm to said lid.

11. The console assembly of claim 10, wherein said third pivot feature includes a seventh pivot pin connecting said fourth link arm to said second storage bin and an eighth pivot pin connecting said fourth link arm to said lid.

12. The console assembly of claim 11, wherein said fifth pivot pin is aligned with said seventh pivot pin and said sixth pivot pin is aligned with said eighth pivot pin.

13. The console assembly of claim 12, further including a latch mechanism for locking said lid in a closed position.

14. The console assembly of claim 1, further including a second pivot feature attaching said lid to said base.

15. The console assembly of claim 14, further including a second storage bin pivotally attached to said lid by a third link arm, a fourth link arm and a third pivot feature.

16. The console assembly of claim 15, wherein said third link arm is opposed to said fourth link arm.

17. The console assembly of claim 16, wherein said third pivot feature includes a fifth pivot pin connecting said third link arm to said second storage bin, a sixth pivot pin connecting said third link arm to said lid, a seventh pivot pin connecting said fourth link arm to said second storage bin and an eighth pivot pin connecting said fourth link arm to said lid.

18. A console assembly, comprising:
a base;
a lid attached to said base; and
a storage bin pivotally attached to said lid by a self-leveling feature, wherein said self-leveling feature includes a first link arm, a second link arm and a pivot feature pivotally attaching said first link arm and said second link arm to said storage bin and said lid.

19. (canceled)

20. The console assembly of claim 18, further including a second pivot feature attaching said lid to said base.
